(19) United States
(12) Patent Application Publication
(10) Pub. No.: US 2007/0097817 A1
(43) Pub. Date: May 3, 2007

(54) Method and system for recording data with data verifying process

(75) Inventors: Yu-Wei Ling, Kaohsiung City (TW); Chun-Ying Chiang, Caotun Township (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Mediatek Inc.

(21) Appl. No.: 11/260,607

(22) Filed: Oct. 27, 2005

(51) Int. Cl. G11B 20/10

(52) U.S. Cl. 369/47.33

(57) ABSTRACT

The present invention is directed to a method and system for recording data from a source via a buffer to a recordable medium. The method comprises receiving a plurality of data blocks from the source to the buffer, recording the plurality of data blocks to the recordable medium, verifying the plurality of recorded data blocks, and receiving a new data block from the source to the buffer after verifying one recorded data block of the recorded data blocks.

### BACKGROUND

The invention relates in general to data recording, and in particular, to a method and system for recording data with a data verifying process.

In specification of some optical storage technologies, such as DVD-RAM, after a data recording system records data on a recordable medium, the data recording system employs a data verification process to maintain an appropriate level of data integrity on a recordable medium. Data recording-verification performance of a data recording system is limited by the time-consuming and resource hungry verification process, since the storage drive may not retrieve further data for recording prior to the completion of previous data verification.

FIG. 1 is a time diagram of unrecorded data level in a buffer of a recording system in a data recording-verification process according to the related art. The data recording-verification process represented by the time diagram comprises the sequence of Phases 100, 102, 104, 106, and 108. In Phase 100, the system receives and holds data from a data source to the buffer. In the related arts, the data will be encoded before being recorded to a recordable medium. In order to explain the data storage process more clearly, this encoding process would be omitted in the following descriptions. But the person skilled in the art would be known that the data from the source would be always encoded before recording onto the recordable medium. In Phase 102, the system seeks a recording location on a recordable medium, such that an optical pick-up head of the recording system can be positioned correctly to record data thereon. In Phase 104, the system records data in the buffer to the recordable medium. In Phase 106, the system seeks verification location on a recordable medium to read data thereon for verification. Phase 108 verifies the data accuracy on the recordable medium after Phase 104.

Upon initialization, unrecorded data level increases steadily until reaching an upper threshold in Phase 100A, where data D1 is transferred from a data source to the buffer. The data level remains at a constant level throughout Phase 102A. Then the data level decreases continuously to a lower threshold during Phase 104A. Next the data level remains constant throughout Phases 106A and 108A of the complete recorded data D1. And the data level increases again in Phase 100B of the next data D2. The buffer space of the buffer is available only for the next data D2 after the verification of Data D1 is completed. Therefore the time consuming of the whole data storage process, including the recording and verification, suffers from the wait for verification in Phase 108.

FIG. 2 is a flowchart of a recording-verification process to realize the buffer level behavior in FIG. 1. Upon initialization in step s200, the buffer receives the first data D1 from the data source. In step S204, the recording system seeks a recording location on the recordable medium. Thus the first data D1 in the buffer can be recorded on the recordable medium started from the recording location in step S206. The system seeks a predetermined verification location on the recordable medium for verification in step S208. The predetermined verification location has the recorded data D1 thereon. Next in step S210, a decoder of the recoding system verifies the complete data D1 on the recordable medium, and determines the verification result of the recorded data D1. If recording status indicates the recording process is incomplete, recording process 20 loops back to step S200 to receive the second data D2, otherwise recording process 20 stops at step S214.

As demand for data access grows, better data recording-verification performance is in favor, so that higher data throughput may be delivered in an unit time. Thus an efficient data storage scheme is needed to speed processing of data recording-verification.

### SUMMARY

The invention is directed to a method and system for recording data from a source via a buffer to a recordable medium. In one embodiment, a recording-verification method comprises receiving a plurality of data blocks from the source to the buffer, recording the plurality of data blocks to the recordable medium, verifying the plurality of recorded data blocks, and receiving new data blocks from the source to the buffer after verifying one of the recorded data blocks.

Another embodiment of the recording-verification method of the present invention comprises receiving a plurality of first data blocks from the source to the buffer, recording the plurality of first data blocks to the recordable medium, verifying the plurality of first data blocks read from the recordable medium, releasing a part of the plurality of first data blocks in the buffer upon verification thereof, and receiving a plurality of second data blocks from the source and buffering in the released buffer space.

In another exemplary embodiment, a recording system for recording data from a source via a buffer to a recordable medium comprises a source interface, a buffer, a recording and verifying module, and a buffer management unit. The source interface receives a plurality of data blocks. The buffer buffers the plurality of data blocks. The recording and verifying module records the plurality of data blocks to the recordable medium, receives a plurality of recorded data blocks from the recordable medium, verifies the recorded data blocks, and then generates a verifying status signal. The buffer management unit receives the verifying status signal. When the verifying status signal indicating one of the recorded data blocks is verified, the buffer management unit generates a transfer control signal to control the source interface to receive new data block, and a buffer control signal to control the buffer to release buffer space of the verified data block to buffer new data block.

### BRIEF DESCRIPTION OF THE DRAWINGS

The invention will become more fully understood from the detailed description, given herein below, and the accompanying drawings. The drawings and description are provided for purposes of illustration only and, thus, are not intended to be limiting of the present invention.

FIG. 1 is a time diagram of an unrecorded data level in a buffer of a recording system according to the related art.

FIG. 2 is a flowchart of a recording-verification process to realize the buffer level behavior in FIG. 1.

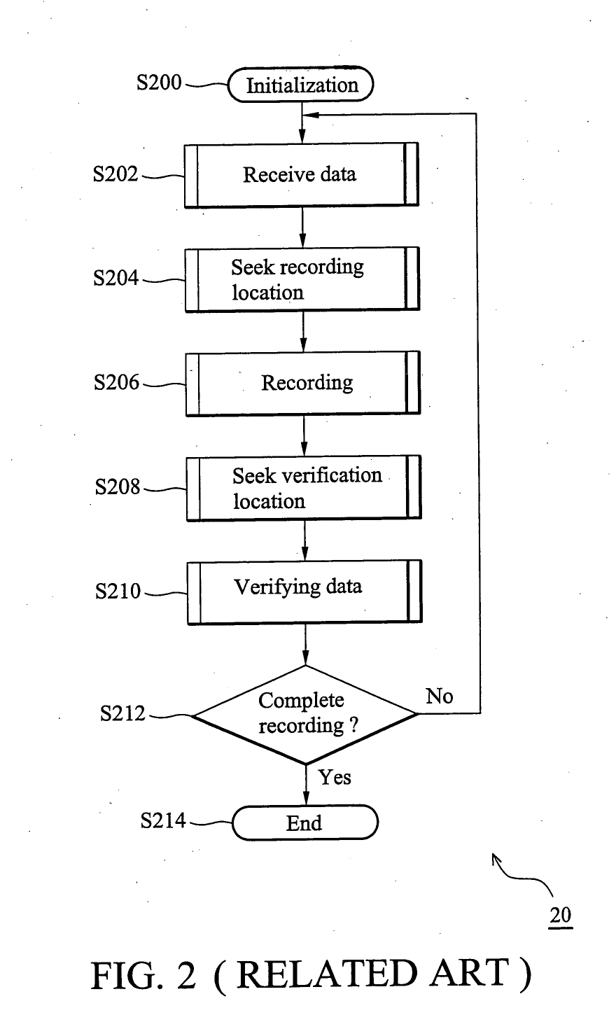

FIG. 3 is a time diagram of an unrecorded data level in a buffer of a recording system according to an embodiment of the invention.

FIG. 4 shows a time diagram of an unrecorded data level in a buffer of a recording system according to another embodiment of the invention.

FIG. 5 is a block diagram of a recording system, a data source, and a recordable medium according to an embodiment of the invention.

FIG. 6 is a flowchart of a recording-verification method according to an embodiment of the invention, incorporating the recording system in FIG. 5.

FIG. 7 is a flowchart of an recording-verification method according to another embodiment of the invention, incorporating the recording method in FIG. 6.

FIG. 8 shows buffer space allocation of the buffer during the recording operation in FIG. 6, incorporated in the recording system in FIG. 5.

FIG. 9 shows buffer space allocation of the buffer during the recording operation in FIG. 6, incorporated in the recording system in FIG. 5.

### DETAILED DESCRIPTION

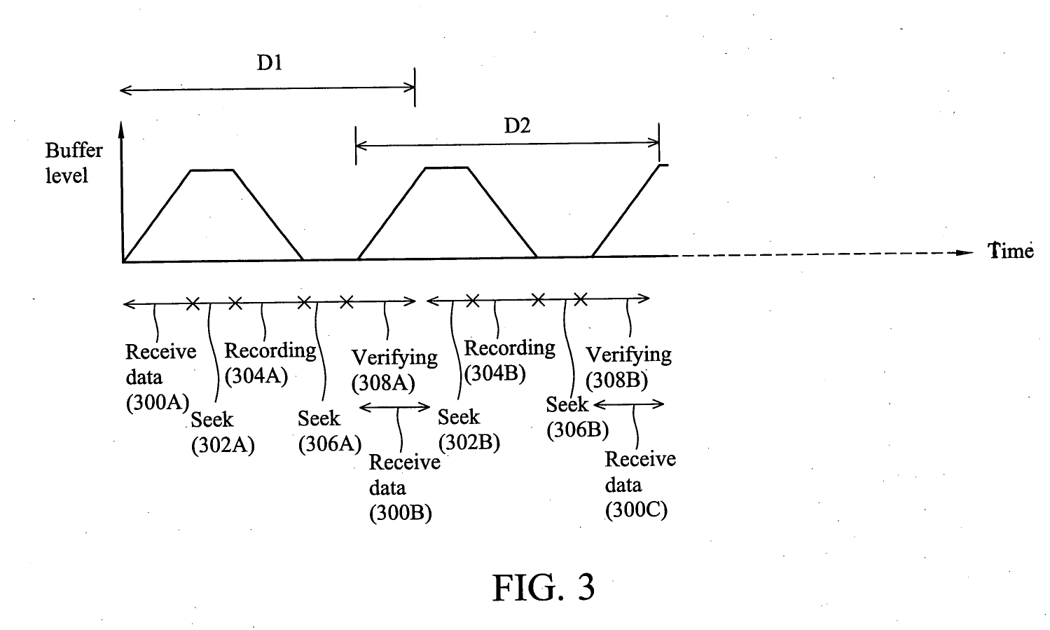

FIG. 3 is a time diagram of an unrecorded data level in a buffer according to an embodiment of the invention, comprising the sequence of Phase 300A, Phase 302A, Phase 304A, Phase 306A, Phase 308A, then reiterated Phase 308A, Phase 302B, Phase 304B, Phase 302B, Phase 308B, and so on. The feature of this embodiment is that the buffer receives the next data from the data source, such as Phase 300B or Phase 300C, during the recording system performing the verification process, such as Phase 308A or Phase 308B.

For clarity, the recorded first data D1 is subdivided into data parts D1₁, D1₂, . . . , D1ᵢ, . . . , D1ₙ, each smaller than data D1. In one of the embodiments, each data parts could be measured as a data block. On the other hand, the recorded first data D1 is subdivided into data blocks D1₁, D1₂, . . . , D1ᵢ, . . . , D1ₙ, in the embodiment. Upon initialization, data level increases steadily until reaching an upper threshold in Phase 300A, where first data D1 is transferred from a data source to the buffer. The data level remains at a constant level during seeking of the recording location in Phase 302A. In the present invention, the data will be encoded before being recorded onto the recordable medium. In order to explain the invention more clearly, this encoding process would be omitted in the following descriptions. But the person skilled in the art would be known that the data from the source would be always encoded before recording onto the recordable medium.

When the recording system starts to record the data onto the recordable medium, the data level decreases continuously to a lower threshold during recording in Phase 304A. Next, the data level remains constant during seeking verification location in Phase 302A and verification of the first recorded data block D1₁ in Phase 308A. The data level increases again with the next data transfer in Phase 300B, while verification of recorded data block D1₂, . . . , D1ₙ is in progress in Phase 308A. The upper threshold level may be the capacity of the buffer, or less than the capacity. The lower threshold level may be zero, or less than the upper threshold level.

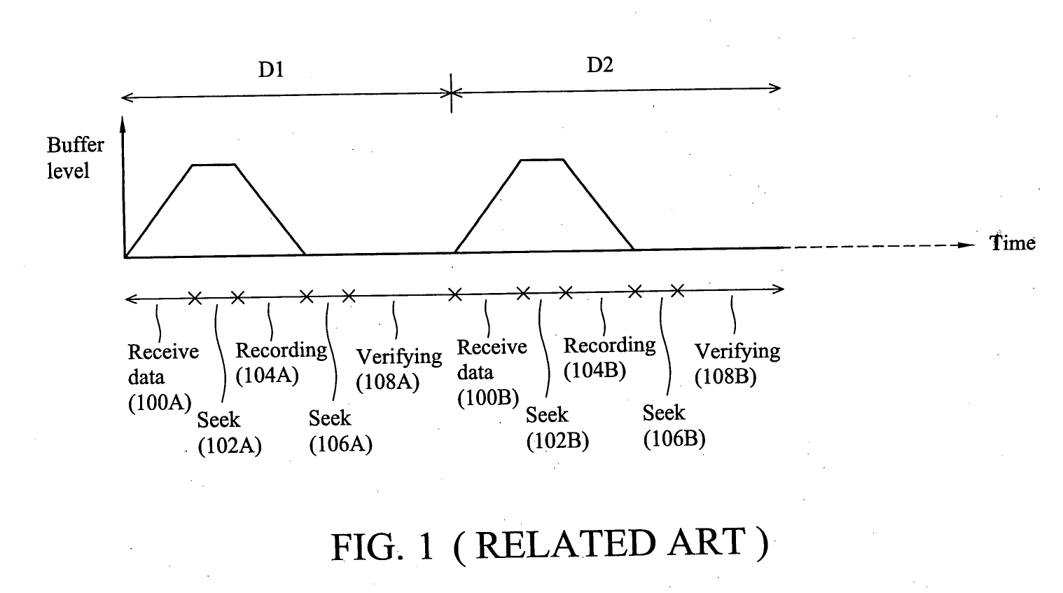

In comparison to FIG. 1, where data transfer in Phase 100B starts after verification in Phase 108A, Phase 300B starts upon partial completion of Phase 308A, resulting in better data storage performance in the invention.

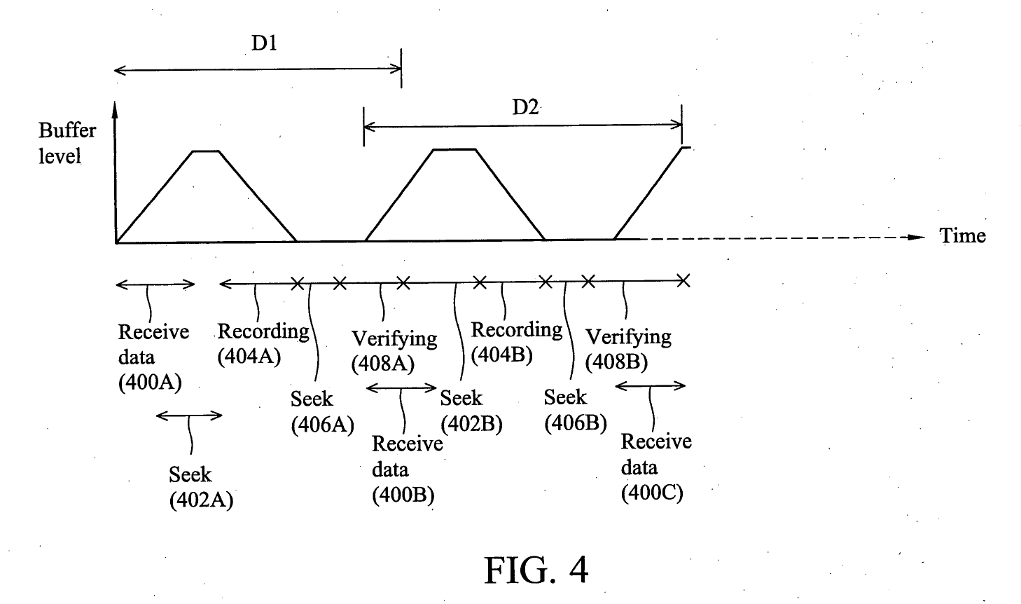

FIG. 4 shows a time diagram of an unrecorded data level in a buffer according to another embodiment of the invention, comprising the sequence of Phase 400A, Phase 402A, Phase 404A, Phase 406A, and Phase 408A, then reiterated Phases 400B, Phase 402B, Phase 404B, Phase 406B, and Phase 408B, and so on. The feature of this embodiment is that when the buffer receives the data from the data source achieved a predetermined level, such as the cross point of the Phase 400A and Phase 402A, or Phase 400B and Phase 402B, the recording system performing the seeking process, such as Phase 402A or Phase 402B. Due to the detail process is similar with the first embodiment, there wouldn't redundantly describe again.

The early data transfer of Phase 400B upon the partial completion of Phase 408A, and the early seek of Phase 402A upon the partial data transfer in Phase 400A renders better data storage performance of the invention, in comparison to the related art in FIG. 1. In comparison to FIG. 3 where seeking process in Phase 302A starts after Phase 300A, Phase 402A starts upon the data buffer achieved the predetermined level in Phase 400A, resulting in better data recording-verification performance in the invention.

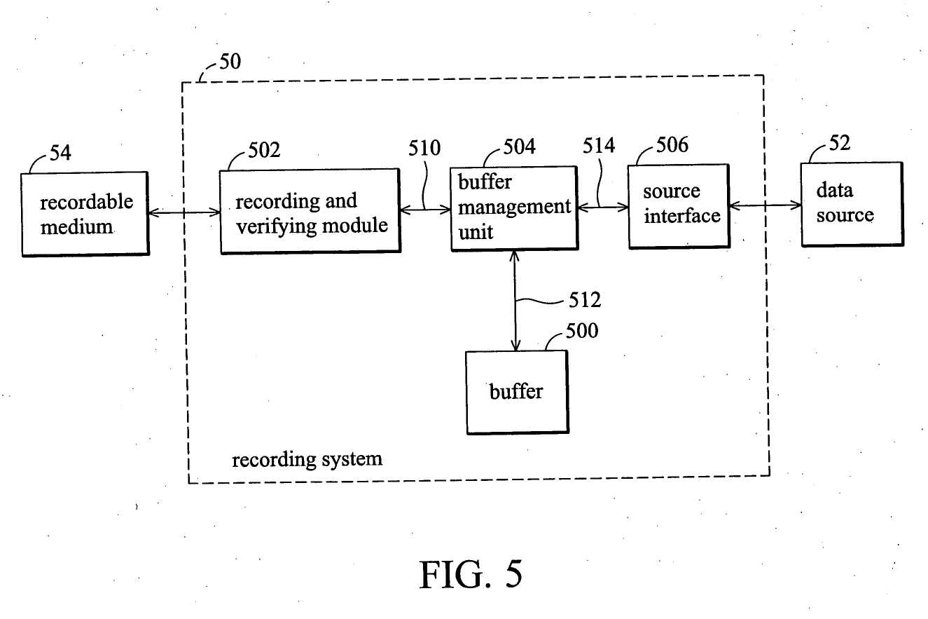

FIG. 5 is a block diagram of a recording system 50, a data source 52, and a recordable medium 54, for realizing the concept of the invention in FIG. 3 and FIG. 4. The recording system 50 comprising a buffer 500, a recording and verifying module 502, a buffer management unit 504, and a source interface 506.

Referring to FIG. 5, buffer 500 is coupled to a buffer management unit 504. The buffer management unit 504 transmits a transfer control signal 514 to the source interface 506 to control the source interface 506 to receive the data D1 from the data source 52, and then transmits the data D1 to the buffer 500. The buffer 500 receives and holds first data D1. The first data D1 comprises a plurality of data blocks which can be recorded onto a recordable medium 54, which may be a DVD-RAM disc or the like. When buffer management 504 determines that the data capacity level of the buffer 500 reaches a predetermined level, the buffer management generate a start signal to the recording and verifying module 502. The recording and verifying module 502 controls data access including read (during seek or verification) and write (during recording) operations to the recordable-medium 54. During recording, the recording and verifying module 502 seeks a recording location on recordable medium 54, and receives and records the recording data D1 from buffer 500 thereto. In verification, the recording and verifying module 502 seeks a verification location on recordable medium 54, then reads data in the verification location to processing the data verification process.

The recording and verifying module 502 receives a part of recorded data D1ᵢ on the recordable medium 54 and verifies the ith part of recorded data D1ᵢ, and outputs verification signal 510 indicating the verification result of the part of recorded data D1ᵢ to buffer management unit 504. Buffer management unit 504 in turn controls buffer 500 through buffer control signal 512, and source interface 506 through transfer control signal 514. the recording and verifying module 502 comprises a data comparator or an error correction code (ECC) decoder to decode the read recorded data and verify the read recorded data. The data comparator compares the part of recorded data D1ᵢ with the corresponding part of the first data D1. The ECC decoder decodes ECC compliant data D1ᵢ, which may be one or more ECC compliant data blocks. ECC compliant data blocks conform to specific rules of construction so that departures from this construction can be automatically detected and corrected. Verification signal 510 may indicate the data comparison result or the decoding status.

If recorded data D1ᵢ is verified successfully, buffer management unit 504 generates buffer control signal 512, and transfer control signal 514, while verification continues for recorded data D1ᵢ₊₁. Buffer control signal 512 releases only the buffer space corresponding to the part of recorded data D1ᵢ in buffer 500. Transfer control signal 514 enables further data retrieval at source interface 506. As more buffer space is released, more buffer space in buffer 500 becomes available for the next data transfer from data source 52. Buffer management unit 504 compares the available buffer space in buffer 500 and requested buffer space from data source 52, and generates transfer control signal 514 if the available buffer space exceeds or equals the requested buffer space. Consequently subsequent second data D2 from data source 52 may be received in the released buffer space. Buffer management unit 504 may also enable source interface 506 to receive partial or full second data D2, subject to the available buffer space at the time. The second data D2 may be a plurality of data blocks compliant with recordable medium 58.

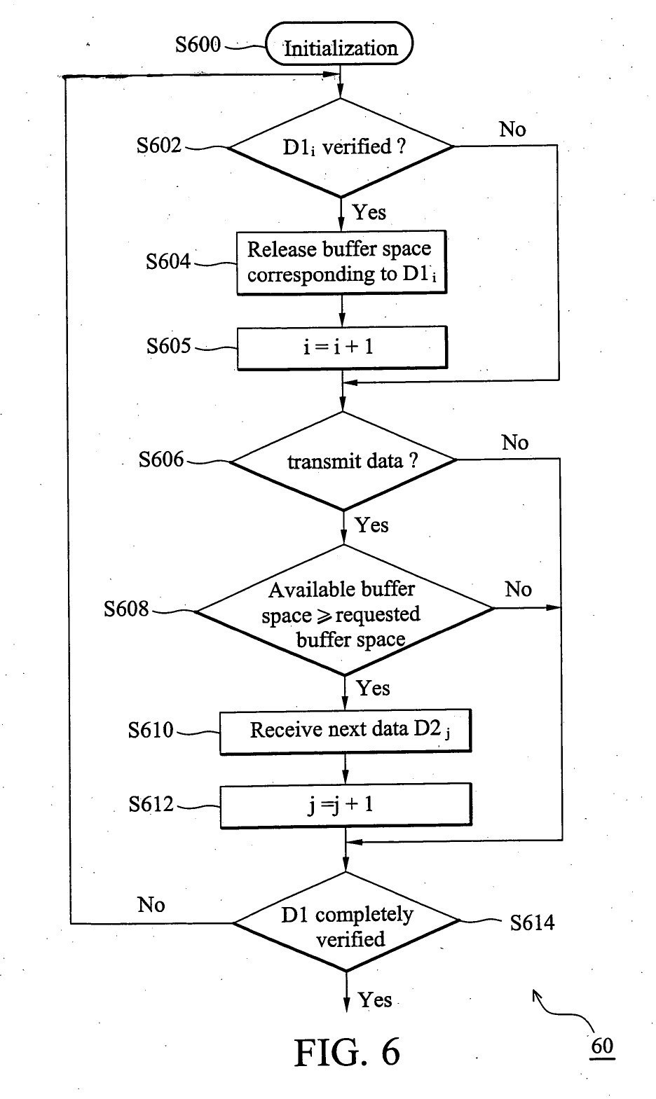

FIG. 6 details a flowchart of a recording-verification method according to an embodiment of the invention, incorporating the recording system in FIG. 5.

During verification, recording-verification method 60 resets counter i=1 and j=1 in step S600, the recording and verifying module 502 determines verification result of the part of recorded data D1ᵢ in step S602. If verification signal 510 indicates the verification result is successful, buffer management unit 504 releases only the buffer space corresponding to the part of recorded data D1ᵢ in buffer 500 by buffer control signal 512 in step S604, otherwise recording method 60 proceeds to step S606.

Next in step S605, counter i is incremented by 1 such that the next portion of data D1ᵢ₊₁ can be verified in the next round of verification.

Followed by step S606, buffer management unit 504 checks for the presence of a transmit command from data source 52. Under the condition where the transmit command is absent, method 60 routes to step S614 so that the verification for data D1ᵢ continues. If the transmit command is present, buffer management unit 504 evaluates the buffer space requested thereby, estimating the available buffer space in buffer 500, and comparing the requested buffer space with the available buffer space in step S608. If the available buffer space exceeds or equals the requested buffer space, i.e., i≧j, recording method 60 proceeds with step S610, otherwise it routes to step S614. In step S610, buffer management unit 504 generates transfer control signal 514 to permit reception of the second data D2ⱼ from data source 52 to buffer 500.

Next in step S612, counter j is incremented by 1 such that the next portion of data D2ⱼ₊₁ can be received at buffer 500 in the next round.

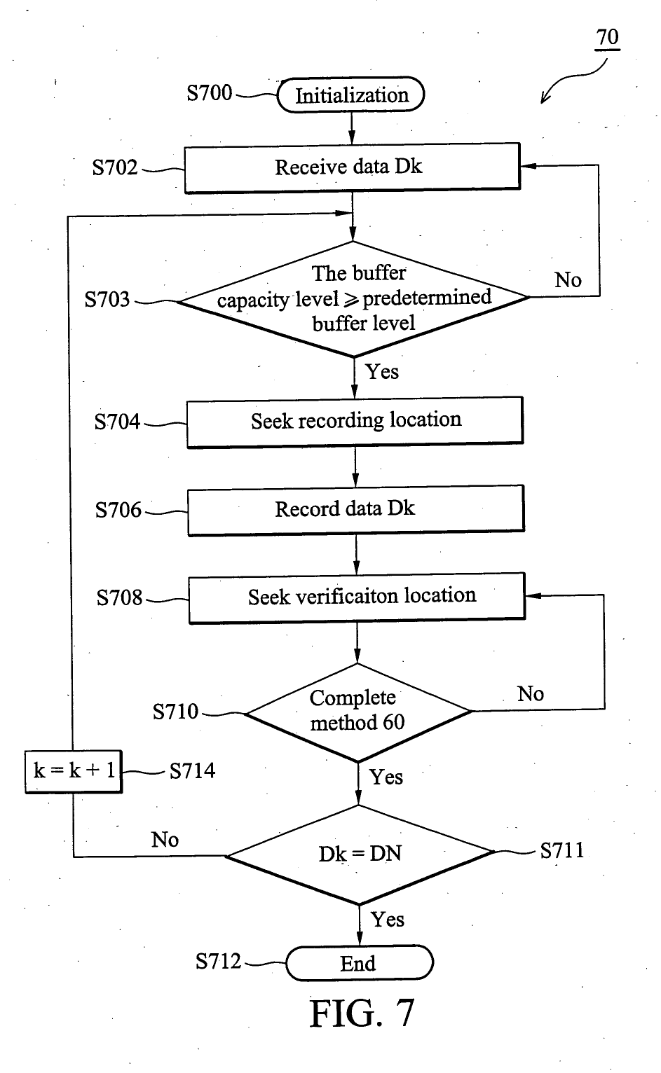

In step S614, buffer management unit 504 determines if data D1 is completely verified, i.e., if the last data D1ₙ is verified. If it is, method 60 is completed and the system keeps going to process the next data D2, otherwise, the verification process continues at step S602 until verification of data D1 is completed. There has to emphasized that the ending of the method 60 only means the data D1 had been verified completely, not means the whole recording-verification process is completed. The system should keep going to record then verify the following data until the whole data being verified. FIG. 7 is a flowchart of an exemplary recording-verification method in the invention, incorporating the recording-verification method 60 in FIG. 6 and the recording-verification system in FIG. 5. FIG. 7 is not only shown the whole data recording-verification process but also shown another feature of the present invention. In comparison to FIG. 3 and FIG. 6, this feature in FIG. 4 and FIG. 7 is that the seeking process starts upon the data buffer achieved the predetermined level, resulting in better data recording-verification performance in the invention.

Upon initialization of method 70, method 70 sets data counter k=1, buffer 500 receives the first data Dk=D1 from data source 52 in step S702. Then the buffer management unit 504 checks if the buffer capacity level achieved a predetermined buffer level in step S703. If the level achieved the predetermined level, the system could start to seek the recording position, proceeding the step S704. If the level is less than the predetermined level, method 70 loops back to step S702 again. The recording and verifying module 502 seeks the recording location on recordable medium 54 in step S704, and records the data Dk in buffer 500 to the recording location in step S706, seeks the verification location on recordable medium 54 to read data Dk thereon in step S708. Next in step S710, recording method 60 is executed and buffer management unit 504 determines if recording method 60 is completed. If method 60 is not completed, method 70 routes to step S708 to seek the verification location and carries out method 60 again, until it is completed. If method 60 is completed, method 70 continues at step S711. In step S711, the buffer management unit 504 determines if data Dk is final data DN in the whole data recording-verification process (k=N?). If the data Dk is the final data DN (k=N and Dk=DN), then method 70 stops at step S712, as the end of the whole data recording-verification process. If the data Dk is not the final data DN (k<N), then let k=k+1 (step S714) and proceeds the step S703 again. As a consequence that buffer delay is reduced, leading to better recording performance and higher buffer utilization rate.

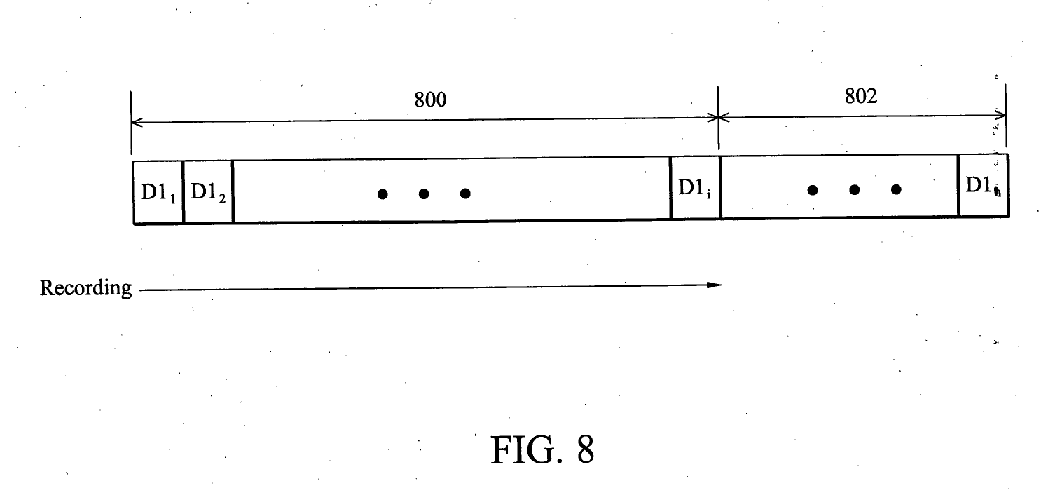

FIG. 8 shows buffer space allocation of buffer 500 during the recording method in FIG. 6, incorporated in the recording system in FIG. 5, comprising recorded data 800 and unrecorded data 802 allocated along the direction of recording progress. The verification step S602 is initiated from the beginning of the recorded data 800, data D1₁, and releases the verified data D1₁ for the next data transfer in step S610.

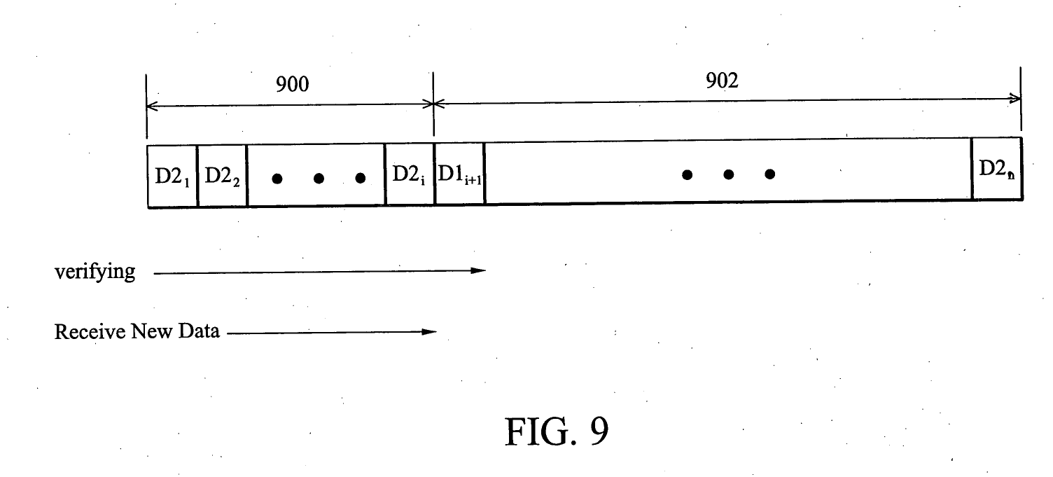

FIG. 9 shows buffer space allocation of buffer 500 during the recording method in FIG. 6, incorporated in the recording system in FIG. 5, comprising unrecorded data 900 and recorded data 902 allocated in agreement with the direction of verification progress in step S602. The second data D2 comprises D2₁, D2₂, . . . , D2ⱼ and arrives the ring buffer at section 900 along the direction of the verification progress. Thus buffer 500 contains the recorded but unverified first data D1ᵢ₊₁, . . . , D1ₙ, and unrecorded second data D2₁, D2₂, . . . , D2ⱼ simultaneously. As a consequence buffer 500 utilization and time reduction due to buffer space allocation is greatly enhanced. Accordingly, a ring buffer could be used in other embodiments.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for recording data from a source via a buffer to a recordable medium, comprising:
receiving a plurality of data blocks from the source to the buffer;
recording the plurality of data blocks to the recordable medium;
verifying the plurality of recorded data blocks; and
receiving new data block from the source to the buffer after verifying one recorded data block of the recorded data blocks.

2. The method of claim 1, further comprising:
evaluating required storage size of the new data block; and
estimating available storage size in the storage buffer; and
wherein the new data block is received at the storage buffer if the available storage size exceeds or equals the required storage size.

3. The method of claim 1 further comprising seeking a predetermined recording location for recording the plurality of data blocks on the recordable medium.

4. The method of claim 1 further comprising seeking a predetermined verification location having recorded data blocks on the recordable medium for verifying the recorded data.

5. The method of claim 3, wherein the seeking operation is performed during receiving the plurality of data blocks.

6. The method of claim 3, further comprising seeking a new predetermined recording location for recording the new data block during receiving a plurality of new data blocks.

7. A method for recording data from a source via a buffer to a recordable medium, comprising:
receiving a plurality of first data blocks from the source to the buffer;
recording the plurality of first data blocks to the recordable medium;
verifying the plurality of first data blocks read from the recordable medium;
releasing a part of the plurality of first data blocks in the buffer when the part of the plurality of first data blocks is verified; and
receiving a plurality of second data blocks from the source at the released buffer space.

8. The method of claim 7, further comprising:
evaluating required storage size of the new data block; and
estimating available storage size in the buffer; and
wherein the receiving step comprises receiving the new data block at the buffer if the available storage size exceeds or equals the required storage size.

9. The method of claim 7, further comprising seeking a predetermined recording location for recording the plurality of data blocks on the recordable medium.

10. The method of claim 7, further comprising seeking a predetermined location having recorded data blocks on the recordable medium for verifying the recorded data.

11. The method of claim 9, wherein the seeking operation is performed during receiving the plurality of data blocks.

12. The method of claim 9, further comprising seeking a new predetermined recording location for recording the new data block during receiving a plurality of new data blocks.

13. A recording system for recording data from a source via a buffer to a recordable medium, comprising:
a source interface for receiving a plurality of data blocks from the source;
a buffer for buffering the plurality of data blocks;
a recording and verifying module for recording the plurality of data blocks to the recordable medium, reading a plurality of recorded data blocks from the recordable medium, verifying the recorded data blocks, and generating a verifying status signal;
a buffer-management unit for controlling the buffer to buffer the plurality of data blocks, and receiving the verifying status signal, when the verifying status signal indicating one of the recorded data blocks is verified, generating a transfer control signal to control the source interface to receive new data block, and a buffer control signal to control the buffer to release buffer space of the verified data block to buffer new data block.

14. The recording system of claim 13, wherein the buffer management unit further evaluates required storage size of the new data block, estimates available storage size in the buffer, and controls the data buffer to receive the new data block if the available storage size exceeds or equals the required storage size.

15. The recording system of claim 13, wherein the recording and verifying module further seeks a new predetermined recording location for recording the new data block after verifying the plurality of recorded data blocks.

16. The recording system of claim 13, wherein the recording and verifying module further seeks a predetermined location having recorded data blocks on the recordable medium for verifying the recorded data.

17. The recording system of claim 15, wherein the recording and verifying module seeks during receiving the plurality of data blocks.

18. The recording system of claim 15, wherein the recording and verifying module further seeks a new predetermined recording location for recording the new data block during receiving a plurality of new data blocks.

19. The recording system of claim 13, wherein the buffer comprises the recorded data blocks and the new data block.
